(19) United States
(12) Patent Application Publication
(10) Pub. No.: US 2012/0018615 A1
(43) Pub. Date: Jan. 26, 2012

(54) PHOTONIC SECOND-ORDER DELTA-SIGMA MODULATOR

(76) Inventors: Azad Siahmakoun, Terre Haute, IN (US); Pablo Alejandro Costanzo-Caso, Buenos Aires (AR)

(21) Appl. No.: 12/841,469

(22) Filed: Jul. 22, 2010

(51) Int. Cl. G01J 1/32; G01J 1/44; G02F 1/01

(52) U.S. Cl. 250/205; 359/238; 250/216; 359/239; 250/214 R

(57) ABSTRACT

The present disclosure relates to devices, systems and techniques for producing asynchronous delta-sigma modulated output signals from an optical input signal. In some examples, a modulator may include a first inverted integrator for producing a first integrated optical signal based on the optical input signal. Example modulators may also include a second inverted integrator for producing a second integrated optical signal based on the first integrated optical signal. Example modulators may also include an optical quantizer for producing an optical output signal based, at least in part, on the second integrated optical signal.

### BACKGROUND

Delta-sigma modulation may be useful in many applications such as information transmission and signal processing environments. Delta-sigma modulation is desired in some applications due to its ability to code amplitude information of an input signal into the duty cycle of a binary output signal.

Previous delta-sigma modulation implementations operate in the electrical domain. Optical processing may be desirable, but many optical implementations (such as coherent optical processing) are typically very unstable, noisy and complicated due to the large number of fiber optic components and external controls.

Many sensors are adapted to receive or sense analog information. Analog-to-digital converters (using asynchronous delta-sigma modulation, or ADSM), process this analog information and provide digital output representation for storage, manipulation, analysis and/or display. ADSM may be used, for example, in communication systems and data transmission applications such as wireless, satellite, radar, radio-over-fiber systems, target tracking, and other similar systems. ADSM may also be utilized in signal processing systems such as data acquisitions equipment, oscilloscopes, imaging systems, data encryption and the like.

In some examples, ADSM may be implemented as a device that for an analog input (amplitude modulated signal) provides a binary output signal whose duty cycle is modulated. This exchange of the amplitude axis for the time axis may offer a possibility of overcoming resolution problems in analog to digital conversion. The ADSM may be used in communication systems and data transmission systems where it is desirable to convey the information in the duty cycle of a binary signal. Further, electronic ADSM may be utilized in wired and/or wireless systems for data, audio and TV transmission.

No viable optical ADSM solution, however, is available. Optical ADSM may be used in optical transmission systems where a message or transmitted information is modulated in the duty cycle and frequency of a binary signal.

Therefore, there is a need for delta-sigma modulation utilizing optical processing. Further, there is a need for incoherent optical processing employing simple components.

### SUMMARY

In an example embodiment, a modulator to produce an asynchronous delta-sigma modulated (ADSM) output signal from an optical input signal may include a first inverted integrator (or accumulator), a second inverted integrator (or accumulator) and an optical quantizer. The first inverted integrator may be operably coupled to the optical input signal, and may produce a first integrated optical signal based, at least in part, on the optical input signal. The second inverted integrator may be operably coupled to the first inverted integrator, and may produce a second integrated optical signal based, at least in part, on the first integrated optical signal. The optical quantizer may be operably coupled to the second inverted integrator, and may produce an optical output signal (e.g., a binary optical output signal) based, at least in part, on the second integrated optical signal.

In another example embodiment, a method for a modulator to produce an asynchronous delta-sigma modulated output signal generated from an optical input signal may include integrating the optical input signal to produce a first integrated optical signal, integrating the first integrated optical signal to produce a second integrated optical signal, and optically quantizing the second integrated optical signal to produce an optical output signal (e.g., a binary optical output signal).

In yet another example embodiment, a system to produce an asynchronous delta-sigma modulated output signal from an optical input signal may include a first inverted integrator, a second inverted integrator, an optical quantizer, output optical coupler and an output photodiode. The first inverted integrator may include an optical isolator, a semiconductor optical amplifier, a bandpass filter and optical coupler(s). The second inverted integrator may include an optical isolator, a semiconductor optical amplifier, a bandpass filter and optical coupler(s). The optical quantizer may include symmetrically coupled PIN structures such as semiconductor optical amplifiers, or a quantizer photodiode, an comparator and a laser.

From the foregoing disclosure and the following detailed description of various preferred embodiments it will be apparent to those skilled in the art that the present invention provides a significant advance in the art. Additional features and advantages of various preferred embodiments will be better understood in view of the detailed description provided below.

### BRIEF DESCRIPTION OF THE SEVERAL VIEWS OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIG. 1 is a schematic diagram of an ADSM architecture in an example embodiment;

FIG. 2 is a schematic diagram of an ADSM architecture in another example embodiment;

FIG. 3 is a schematic diagram of an ADSM architecture in yet another example embodiment;

FIG. 4 is a schematic diagram of an ADSM architecture in another example embodiment;

FIG. 5 is a flowchart showing the operation of an example embodiment;

FIG. 6 is a graphical representation of analog input and binary output signals of an example embodiment;

FIG. 7 is a graphical representation of analog input and binary output signals of another example embodiment;

FIG. 8 is a graphical representation of analog input and binary output signals of yet another example embodiment; and

FIG. 9 is a graphical representation of analog input and binary output signals of still another example embodiment.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

This disclosure is drawn, inter alia, to devices, systems and methods related to electro-optical environments for asynchronous delta-sigma modulation.

In some examples, an optical delta-sigma modulator may be a device which modulates the duty cycle of a binary signal with the amplitude information of the input analog signal. Some examples may include two inverted leaky integrators and an electro-optic quantizer in the forward path, and a feedback loop. The order of the modulator is defined by the number of loops within the system. In some examples, the integrators may be accumulators.

In some examples, the input analog signal may modulate the optical carrier of a continuous wave laser and may be introduced to the main loop through an optical coupler. A second input to the coupler may be given by the quantized output through a feedback fiber-optic loop. Both signals may be processed in two accumulators followed by a quantizer, all which may be positioned in the forward path of the delta-sigma modulator. An optical coupler/splitter at the output of the quantizer may be used to provide an output binary signal and the feedback signal. The two inverted accumulators may be based in active non-linear loops and the electro-optic quantizer may employ an opto-electronic bistable switch such as symmetrically coupled semiconductor optical amplifiers (SOA) or a comparator circuit that modulates the current into an electro-absorption modulator integrated with a continuous wave laser.

Previous modulators processed signals in the electrical domain. Coherent optical processing has also been suggested but it is unstable, noisy and difficult to implement due to the number of required components and external control stability.

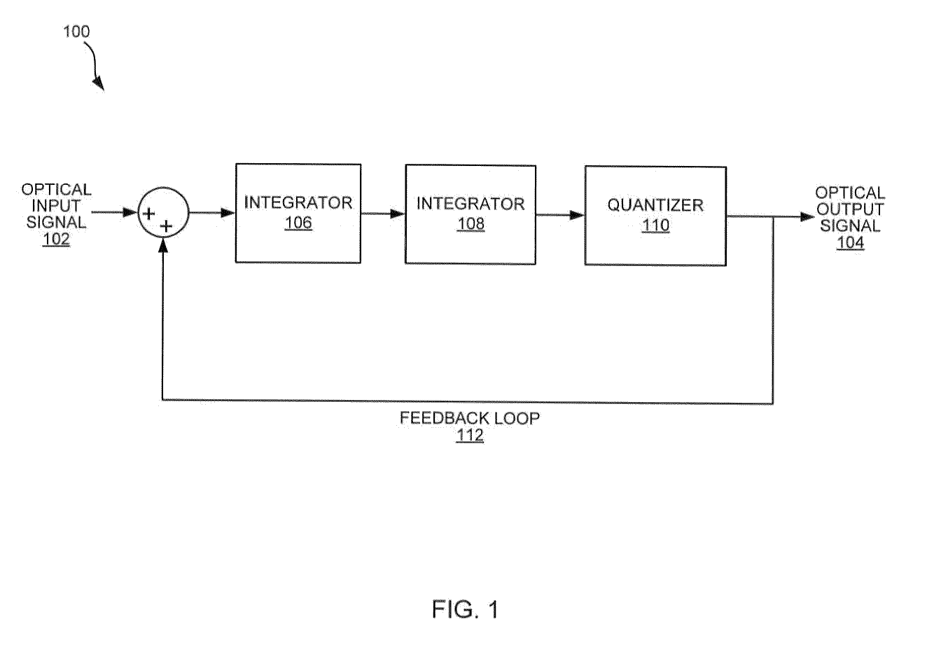

FIG. 1 is a schematic diagram of an ADSM architecture arranged in accordance with an example embodiment. As shown in FIG. 1, modulator 100 may be adapted to produce an asynchronous delta-sigma modulated output signal. Modulator 100 may include first inverted integrator/accumulator 106, second inverted integrator/accumulator 108, optical quantizer 110 and feedback loop 112. First inverted integrator 106 may receive analog input signal 102, which may be an optical signal modulated by an electrical input. First inverted integrator 106 may produce an integrated optical signal based, at least in part, on input signal 102. Second inverted integrator 108 may receive first inverted integrator's 106 integrated optical signal to produce a second integrated optical signal. Optical quantizer 110 may receive second inverted integrator's 108 integrated optical signal to produce an optical output signal 104 (e.g., an optical binary output signal). Feedback loop 112 may alter input signal 102 based, at least in part, on optical output signal 104. In some examples, first inverted integrator 106 and/or second inverted integrator 108 may be leaky integrators and/or inverted leaky integrators. Further, in some examples, optical quantizer 110 may be a binary quantizer.

An optical inverted leaky integrator modulator in accordance with the present invention may allow for an active loop operating with a SOA in the non-linear gain region and accumulation produced at a different wavelength than the corresponding input signal. Since the inverted leaky integrator produces an inverted output, two inverted leaky integrators may be combined for accumulation. In this manner, a second-order ADSM may produce a cleaner signal with reduced fluctuation at the output of the quantizer. Previous optical integrators are based on passive components like fiber Bragg gratings and active loops where the amplifiers are operating in the linear region.

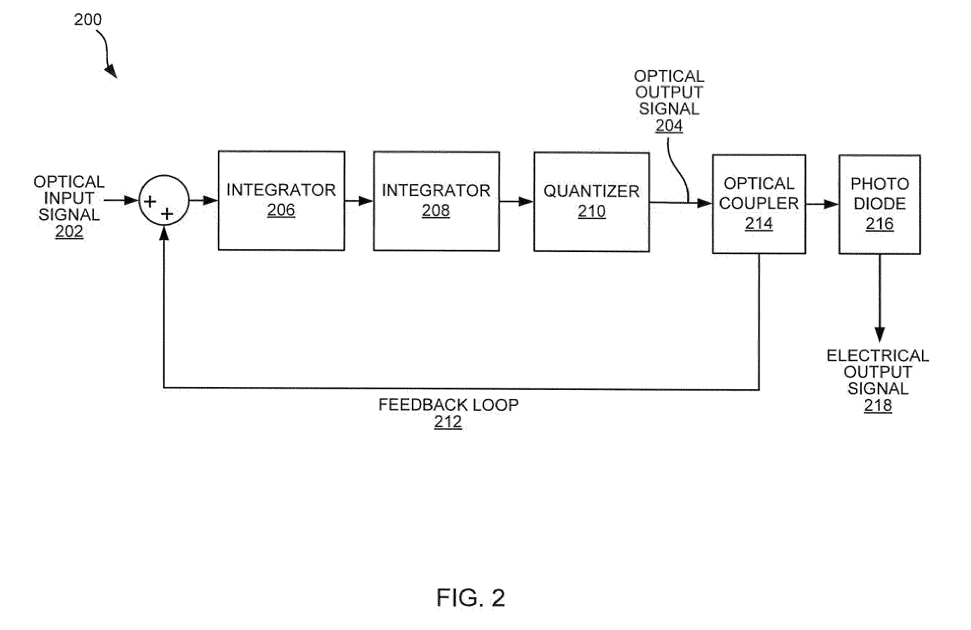

FIG. 2 is a schematic diagram of an ADSM architecture arranged in accordance with another example embodiment. As shown in FIG. 2, modulator 200 may be adapted to produce an asynchronous delta-sigma modulated output signal. Modulator 200 may include first inverted integrator 206, second inverted integrator 208, optical quantizer 210, feedback loop 212, optical coupler 214 and photodiode 216. First inverted integrator 206 may receive optical input signal 202. First inverted integrator 206 may produce an integrated optical signal based, at least in part, on input signal 202. Second inverted integrator 208 may receive first inverted integrator's 206 integrated optical signal to produce a second integrated optical signal. Optical quantizer 210 may receive second inverted integrator's 208 integrated optical signal to produce an optical output signal 204. Feedback loop 212 may alter input signal 202 based, at least in part, on optical output signal 204 (e.g., a binary optical output signal). Optical coupler 214 may receive optical output 204 to produce an optically coupled signal. Photodiode 216 may receive the optically coupled signal to produce electrical output signal 218 (e.g., a binary electrical output signal). In some examples, output photodiode 216 may produce an electrical not-return-to-zero binary output signal.

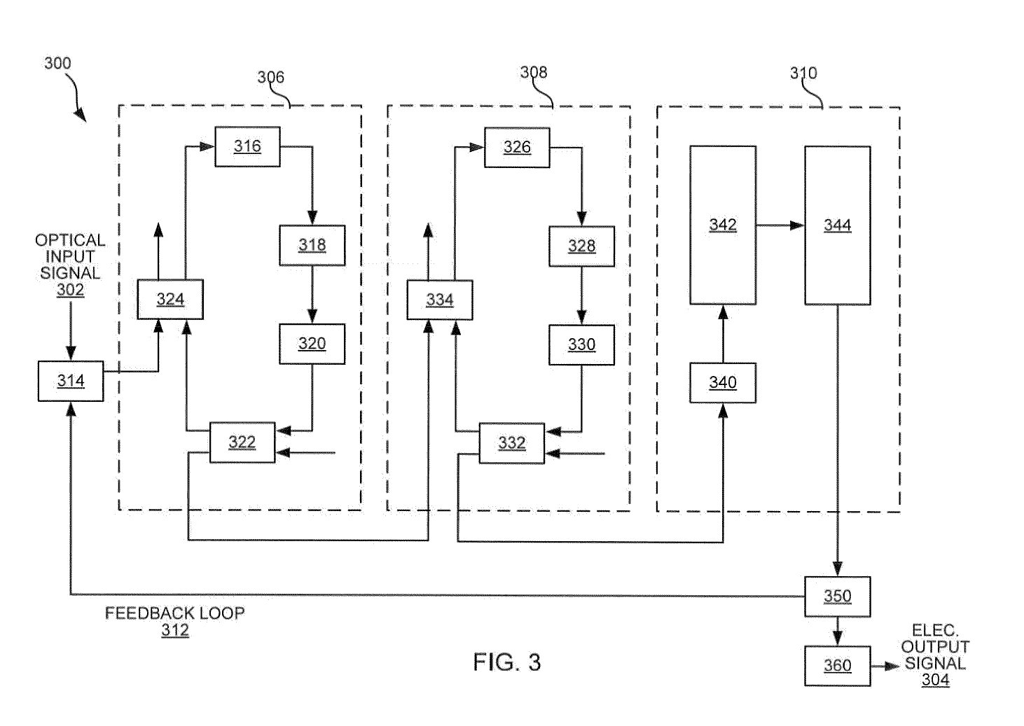

FIG. 3 is a schematic diagram of an ADSM architecture arranged in accordance with yet another example embodiment. As shown in FIG. 3, modulator 300 may be adapted to produce an asynchronous delta-sigma modulated output signal. Modulator 300 may include first inverted integrator 306, second inverted integrator 308, optical quantizer 310, feedback loop 312, optical coupler 314, optical coupler 350 and photodiode 360. Optical coupler 314 may receive optical input signal 302. In some examples, optical coupler 314 may be a 50/50 optical coupler.

In some embodiments, first inverted integrator 306 may include first optical isolator 316, first semiconductor optical amplifier 318, first bandpass filter 320 and optical couplers 322, 324. First optical isolator 316 may receive the optical input signal 302 from optical coupler 314 to produce a first inverted integrator optical signal. First semiconductor optical amplifier 318 may receive the first inverted integrator optical signal and produce a first amplified inverted integrator optical signal. First bandpass filter 320 may receive the first amplified inverted integrator optical signal and produce a first filtered optical signal. Optical couplers 322, 324 may receive the first filtered optical signal to produce the first integrated optical signal. In some examples, optical coupler 322 may be a 30/70 optical coupler. In some examples, optical coupler 324 may be a 50/50 optical coupler.

In some embodiments, second inverted integrator 308 may include second optical isolator 326, second semiconductor optical amplifier 328, second bandpass filter 330 and optical couplers 332, 334. Second optical isolator 326 may receive the first integrated optical signal from optical coupler 322 to produce a second inverted integrator optical signal. Second semiconductor optical amplifier 328 may receive the second inverted integrator optical signal and produce a second amplified inverted integrator optical signal. Second bandpass filter 330 may receive the second amplified inverted integrator optical signal and produce a second filtered optical signal. Optical couplers 332, 334 may receive the second filtered optical signal to produce the second integrated optical signal. In some examples, optical coupler 332 may be a 30/70 optical coupler. In some examples, optical coupler 334 may be a 50/50 optical coupler.

In some embodiments, optical quantizer 310 may include quantizer photodiode 340, comparator 342 and laser 344. Quantizer photodiode 340 may receive the second integrated optical signal to produce a first quantizer signal. Comparator 342 may produce a second quantizer signal. Laser 344 may produce an optical output signal based, at least in part, on the second quantizer signal. Example lasers 344 may include a continuous wave laser, a distributed feedback laser and/or an electro-absorption/optic modulator, among others.

In some embodiments, optical coupler 350 may receive the optical output signal. In some examples, optical coupler 350 may be a 10/90 optical coupler. Feedback loop 312 may alter optical input signal 302 based, at least in part, on the optical output signal. Photodiode 360 may receive optical output signal from the optical coupler 350 to produce output signal 304.

A mathematical model for an example modulator follows. A mathematical model for the integrator will first be discussed. The model parameters that define the performance of the integrator are related to the characteristics of the optical components. A discrete leaky integrator may be represented by the difference equation:

$$y [ n ] = τ y [ n - 1 ] + g x [ n ] = {τ}^{n} y [ 0 ] + g {\sum }_{k = 0}^{n - 1} {τ}^{k} x [ n - k ] \qquad ( Eq . 1 )$$

where x and y are the input and output signals, and g and τ are real constants where g>0 and 0<τ<1, and n≧1. The z-domain transfer function is:

$${H}_{LI} ( z ) = \frac{g}{1 - τ {z}^{- 1}} = g {\sum }_{k = 0}^{∞} {τ}^{k} {z}^{- k} \qquad ( Eq . 2 )$$

where z is the transform variable defined by z=exp(jωT), with T being the sampling period of the integrator and ω being the angular frequency where the region of convergence is |z|>|τ|. Therefore, the impulse response may be defined in terms of the unit step function u[n] as:

h_{1.1}[n]=gτⁿu[n] (Eq. 3)

where u[n]=1 for n≧0, and zero for n<0. The impulse response has infinite terms and decays with time more slowly as τ approaches 1.

A discrete inverted-leaky integrator may be represented by the difference equation:

$$\begin{matrix}y [ n ] = a + τ y [ n - 1 ] - g x [ n ] \\ = a \frac{1 - {τ}^{n + 1}}{1 - τ} + {τ}^{n} y [ 0 ] + g {\sum }_{k = 0}^{n - 1} {τ}^{k} [ n - k ]\end{matrix} \qquad ( Eq . 4 )$$

where x and y are the input and output signals and a, g and τ are real constants which fulfill 0<g≦a and 0<τ<1. Unlike Eq. 1, Eq. 4 does not represent a discrete, linear, and time-invariant system and thus cannot be characterized by the impulse response and transfer function. However, assuming a=0, the system can be described by the z-transfer function and the impulse response and can be expressed as:

$$\begin{matrix}{H}_{ILI} ( z ) = \frac{- g}{1 - τ {z}^{- 1}} = - g {\sum }_{k = 0}^{∞} {τ}^{k} {z}^{- k} & ( Eq . 5 ) \\ {h}_{ILI} [ n ] = - g {τ}^{n} u [ n ] & ( Eq . 6 )\end{matrix}$$

where the region of convergence is |z|>|τ|.

For the non-inverted integrator, the impulse response generally maintains high values for longer time intervals at high τ values. This means that the integrated output signal will depend on a greater number of previous samples of the input signal.

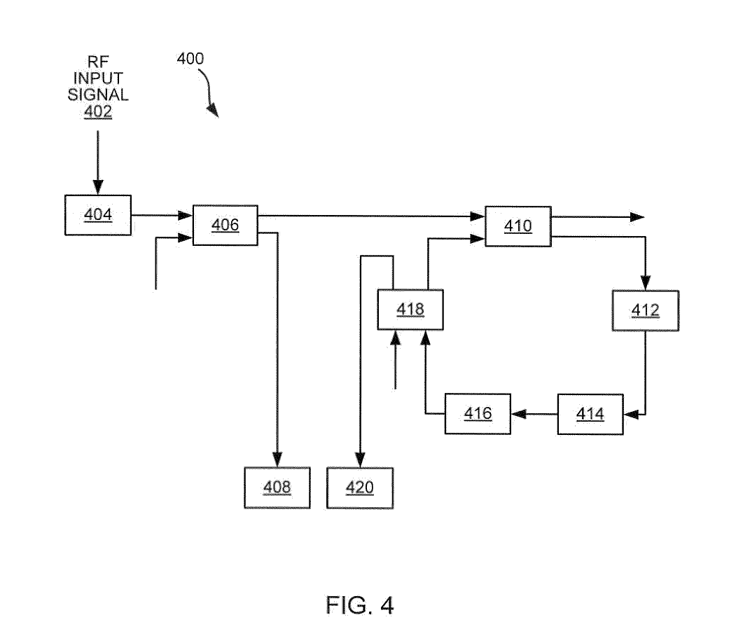

A model for an example integrator 400 employing commercial fiber-optic components may be based on the optical active loop shown in FIG. 4. An input analog signal 402 may modulate the optical carrier of a continuous wave laser 404 and may be introduced to the loop through a variable optical couple (VOC) 406. VOC 406 may be employed to control and measure the input power to the integrator. The loop may include a semiconductor optical amplifier (SOA) 414, an optical isolator (OI) 412, a bandpass filter (BPF) 416 and two optical couplers (OC): OC₁ 410 to couple the input signal into the loop and OC₂ 418 to couple the output signal out of the loop. The output coupler OC₂ 418 may be used to extract the signal circulating within the loop at the filter wavelength. A photodiode 408 may be operably coupled to the VOC 406. A photodiode 420 may be operably coupled to the OC₂ 418.

Qualitatively, an example optical integrator may be described as follows: the optical filter defines the resonance wavelength of the loop at λ₂ (the integration wavelength) which must be different from the input wavelength λ₁ in order to avoid interference effects. The SOA is operated in the nonlinear gain region. Due to the cross-gain modulation phenomenon (XGM) the input signal at λ₁ modifies the SOA gain: high gain for low input powers and low gain otherwise. The accumulated circulating signal at λ₂ increases when the gain exceeds the loss in the loop (i.e. low input signal at λ₁), or decreases when the gain is lower than the loss (i.e. high input signal at λ₁).

The leaky behavior of the integrator may be explained as follows: the analog input signal establishes a gain in the SOA which is repeatedly modified by the re-circulating power in every loop. Considering that the input signal is low at the initial state, then the gain and the output signal are high. When the input signal becomes high, the SOA gain decreases and results in an overall gain that is lower than the loop-loss. Hence, the re-circulating signal decreases and the SOA gain increases in every loop; consequently, the rate of power-decrease in the output signal is reduced. On the contrary, if the initial state of the integrator is given by a high input signal, the opposite behavior will take place. That is, the re-circulating signal increases while the SOA gain decreases in every loop. In this case, the rate of power-increase in the output signal is reduced. Notice that the input signal may be eliminated by the optical filter, thus it does not circulate in the loop. Therefore, the output signal of the inverted leaky integrator may only include the optical carrier component at wavelength λ₂ and may be observed through the OC₂. Furthermore, the re-circulating signal at λ₂ may also be acquired by properly filtering the signal at the output of coupler OC₁.

Since the integrator operates with two signals at different wavelengths, a mathematical model may be built using intensity values. Let the modulated input signal at wavelength λ₁ in port 1 of OC₁ be denoted by I₁^{λ}^{₁} and the delayed output signal at wavelength λ₂ in port 2 by I₂^{λ}^{₂}, while I₃^{λ}^{_{1.2}} and I₄^{λ}^{_{1.2}} are the corresponding intensities in ports 3 and 4, respectively. The optical couplers OC₁ and OC₂ have coupling intensity coefficients K₁ and K₂, the SOA has a gain G which is a function of the intensity I₃^{λ}^{_{1.2}}, and the loop loss α is the sum of the insertion loss in the optical filter, the optical isolator, and the propagation loss in the fiber. The sampling period T of the integrator (i.e. the delay introduced by the loop) defines the interval between consecutive samples, which is given by n (maximum operation frequency of the integrator). The sampling frequency or free spectral range (FSR) for the loop may be given by FSR=1/T=c/(n_{eff}L), where c is the speed of light, n_{eff} is the effective refractive-index, and L is the loop length.

Further, an example leaky integrator may be defined by the set of discrete equations:

I₃^{λ}^{_{1.2}}[n]=K₁I₁^{λ}^{ₜ}[n]+(1−K₁)I₂^{λ}^{₂}[n−1] (Eq. 7)

G[n]=A−BI₃^{λ}^{_{1.2}}[n] (Eq. 8)

I₂^{λ}^{₂}[n]=Cα(1−Kₜ)(1−K₂)G[n] (Eq. 9)

where A, B and C are real constants with the sampling period T defined as the interval between samples. In Eq. 8, a negative-slope linear approximation for G is used to indicate that the SOA is operating in the gain saturation region. In Eq. 9, I₂^{λ}^{₂} is shown to be directly proportional to the SOA gain G. To determine the intensity in port 2 of OC₁, which is also proportional to the output intensity through OC₂, Eqs. 7-9 are combined as follows:

I₂^{λ}^{₂}[n]=a+τI₂^{λ}^{₂}[n−1]−gI₁^{λ}^{₁}[n] (Eq. 10)

Eq. 10 is similar to Eq. 4 with the constants defined as: a=ACα(1−K₁)(1−K₂), τ=−BCα(1−K₁)²(1−K₂), and g=BCαK₁(1−K₁)(1−K₂). Thus, an example modulation device may be considered as an inverted leaky integrator whose properties depend on the gain/loss in the loop and the coupling ratio of the couplers.

Some example embodiments provide that first inverted integrator 106, 206, 306 may be based, at least in part, on the equation I₂^{λ}^{₂}[n]=a+τI₂^{λ}^{₂}[n−1]−gI₁^{λ}^{₁}[n]. In this equation, n is a time value, λ₁ is a first wavelength associated with the optical input signal, λ₂ is a second wavelength associated with first bandpass filter 320, a=AC(1−K₁)(1−K₂), τ=−BCα(1−K₁)²(1−K₂) and g=−BCαK₁(1−K₁)(1−K₂). Further, A is a first real constant, B is a second real constant, and C is a third real constant. Even further, K₁ and K₂ are first coupling coefficients and second coupling coefficients, respectively.

Some example embodiments provide that second inverted integrator 108, 208, 308 may be based, at least in part, on the equation I₂^{λ}^{₂}[n]=a+τI₂^{λ}^{₂}[n−1]−gI₁^{λ}^{₁}[n]. In this equation, n is a time value, λ₁ is a first wavelength associated with the first integrated optical signal, λ₂ is a second wavelength associated with the second bandpass filter 330, a=AC(1−K₁)(1−K₂), τ=−BCα(1−K₁)²(1−K₂) and g=−BCαK₁(1−K₁)(1−K₂). Further, A is a first real constant, B is a second real constant, and C is a third real constant. Even further, K₁ and K₂ are first coupling coefficients and second coupling coefficients, respectively.

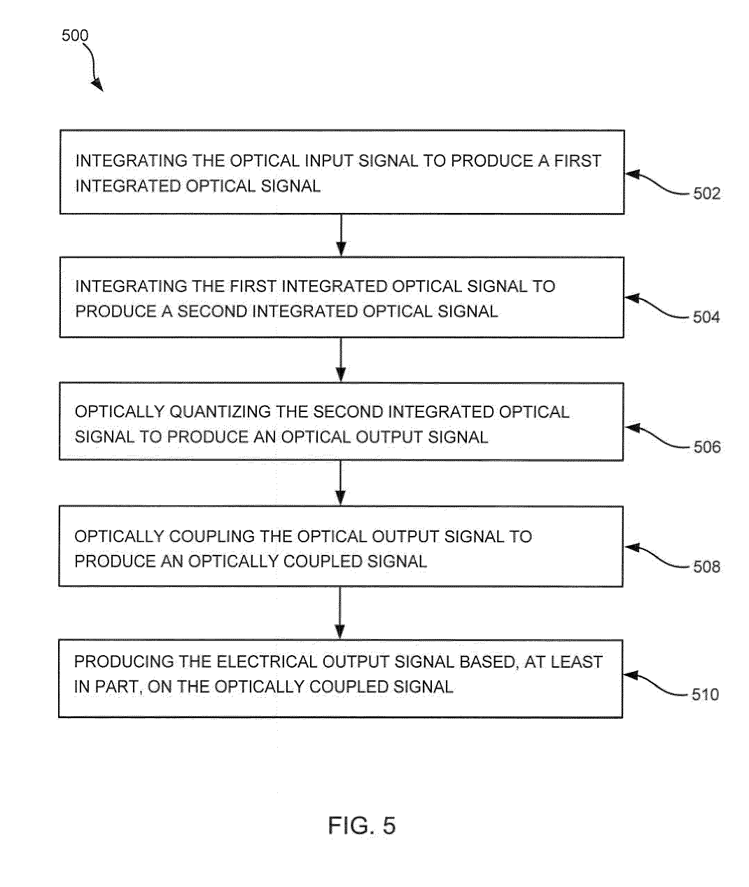

Some example embodiments may include a method for producing an asynchronous delta-sigma modulated output signal generated, at least in part, from an optical input signal, which may operate as depicted by the flowchart of FIG. 5. The illustrated embodiment may include one or more of processing operations 502, 504, 506, 508 and 510. Operation 502 may include integrating an optical input signal to produce a first integrated optical signal. Operation 504 may include integrating the first integrated optical signal to produce a second integrated optical signal. Operation 506 may include optically quantizing the second integrated optical signal to produce an optical output signal. Operation 508 may include optically coupling the optical output signal to produce an optically coupled signal. Operation 510 may include producing an electrical output signal (e.g., electrical binary output signal) based, at least in part, on the optically coupled signal.

Additional example embodiments may provide for methods that further include altering the optical input signal based, at least in part, on the optical output signal, and repeating integrating operations 502, 504 and optically quantizing operation 506 for the altered optical input signal.

In some example embodiments, a modulator architecture may be configured to implement one or more operations of FIG. 5.

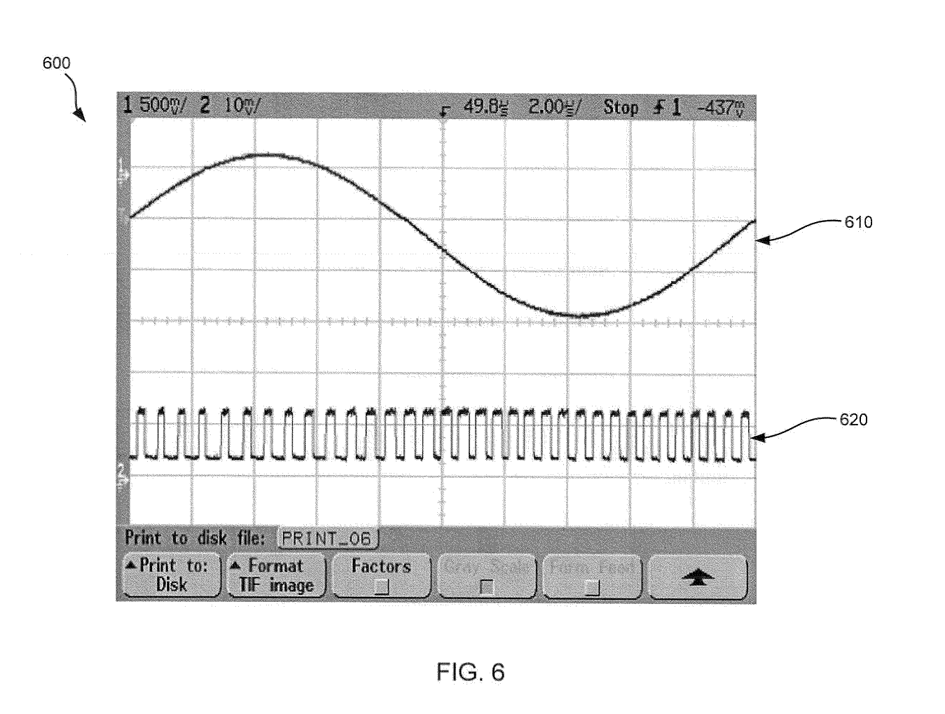

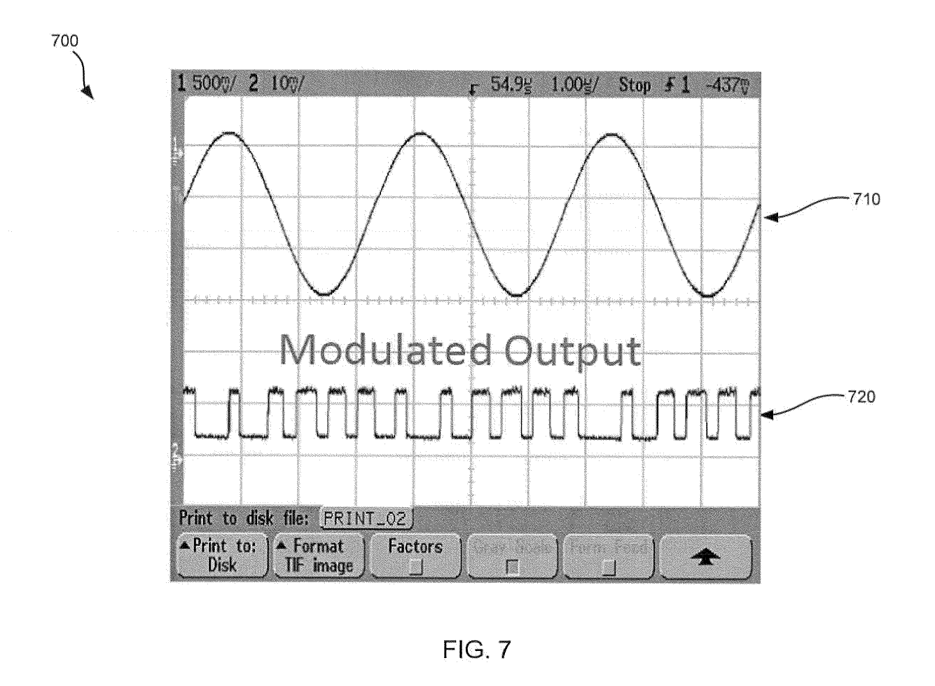

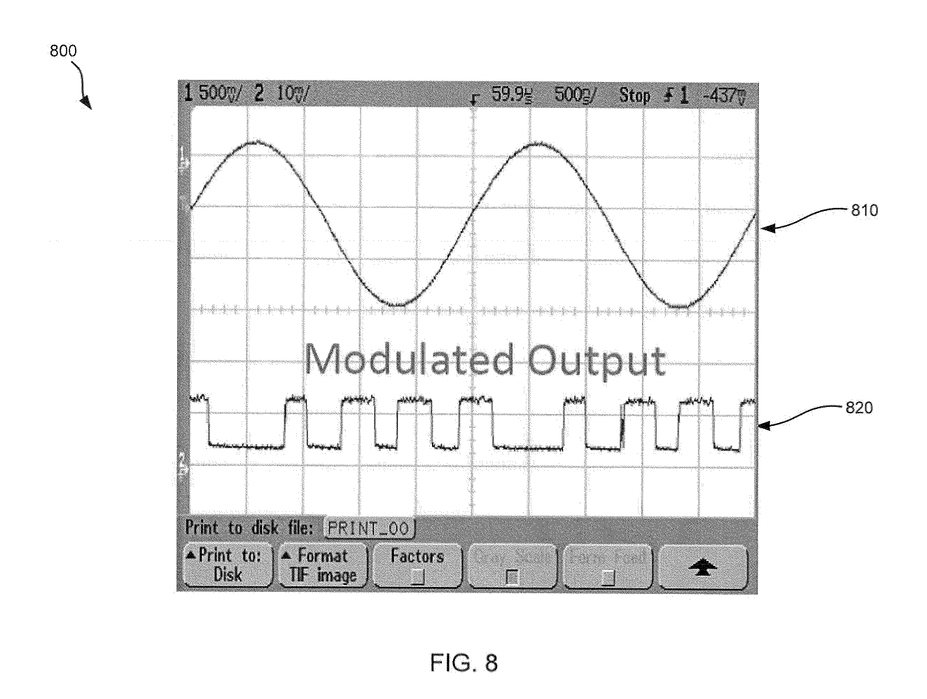

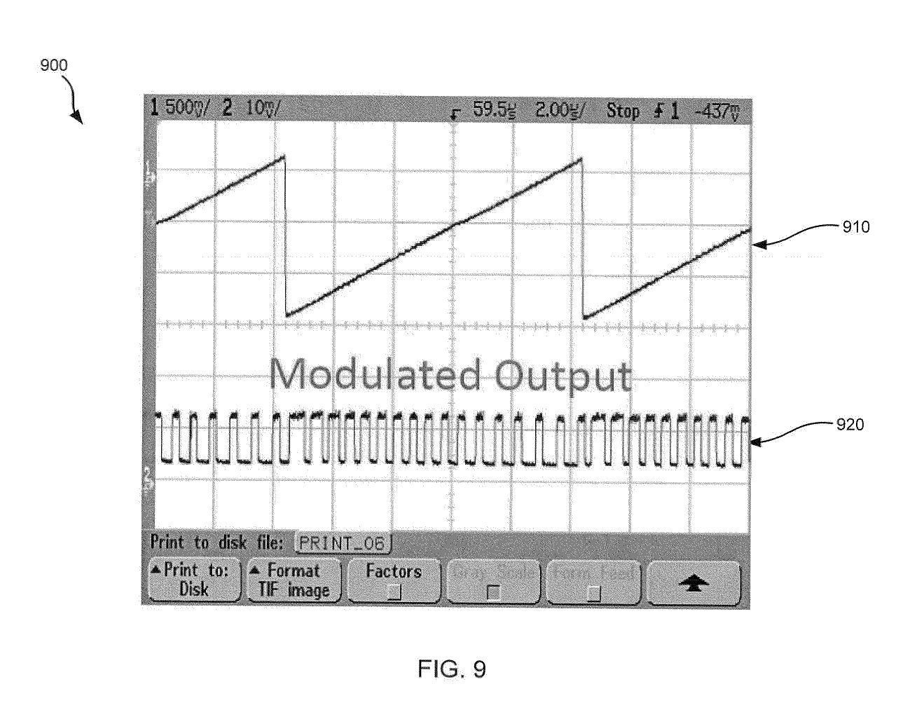

FIGS. 6-9 are graphical representations of input and output signals of example embodiments. FIG. 6 depicts a sinusoidal input signal 610 having a frequency of 50 kHz and the corresponding modulated output signal 620. FIG. 7 depicts a sinusoidal input signal 710 having a frequency of 300 kHz and the corresponding modulated output signal 720. FIG. 8 depicts a sinusoidal input signal 810 having a frequency of 400 kHz and the corresponding modulated output signal 820. FIG. 9 depicts a sawtooth input signal 910 having a frequency of 100 kHz and the corresponding modulated output signal 920.

It can be seen in FIGS. 6-9 that output signals have binary amplitude which depend on the output levels of the opto-electronic quantizer, according to some embodiments. The modulated output may be demodulated employing a low pass filter that produces the mean value of the binary output. Because the optical quantizer produces an inverted output, the modulated signal remains at low level for a longer period of time for higher inputs and at high level otherwise. The duty cycle and the frequency of the modulated output may depend on the amplitude of the input signal but are independent of the input frequency. Therefore, in some examples, the difference between the output signals corresponding at different input frequencies is the number of pulses present in a period of the binary output signal.

A leaky integrator constructed according to the present invention is capable of producing both inverted and non-inverted output signals. One of the advantages of this integrator is that the time constant of the integrator can be easily adjusted over the whole range of the input period by controlling the SOA current. This feature makes the integrator suitable for implementation in an all-optical sigma-delta modulator and other signal processing applications. The length of the fiber loop limits the maximum input frequency to a few MHz. However, if the fiber loop length is reduced to tenths of a centimeter, then the operation frequency can reach a few GHz. Moreover, the theoretical limitation for the maximum frequency response for the integrator is established by the shortest length of the loop and the fastest gain recovery time of the SOAs. Therefore, by using microfabricated loops with radii of tens of micrometers (i.e., free spectral range of hundreds of GHz) and SOAs with tens of pico-seconds gain recovery time, an optical leaky integrator with an adjustable time constant operating at about 100 GHz could be fabricated employing current integrated photonic technology.

Following from the above description and invention summaries, it should be apparent to those of ordinary skill in the art that, while the methods and apparatuses herein described constitute exemplary embodiments of the present invention, it is to be understood that the inventions contained herein are not limited to the above precise embodiment and that changes may be made without departing from the scope of the invention. Likewise, it is to be understood that it is not necessary to meet any or all of the identified advantages or objects of the invention disclosed herein in order to fall within the scope of the invention, since inherent and/or unforeseen advantages of the present invention may exist even though they may not have been explicitly discussed herein.

What is claimed is:

1. A modulator to produce an asynchronous delta-sigma modulated output signal, at least in part, from an optical input signal, comprising:
a first inverted integrator operably coupled to the optical input signal, the first inverted integrator adapted to produce a first integrated optical signal based, at least in part, on the optical input signal;
a second inverted integrator operably coupled to the first inverted integrator, the second inverted integrator adapted to produce a second integrated optical signal based, at least in part, on the first integrated optical signal; and
an optical quantizer operably coupled to the second inverted integrator, the optical quantizer adapted to produce an optical output signal based, at least in part, on the second integrated optical signal.

2. The modulator of claim 1, further comprising:
an output optical coupler operably coupled to the optical quantizer, the output optical couple adapted to produce an optically coupled signal based, at least in part, on the optical output signal; and
an output photodiode operably coupled to the output optical coupler, the output photodiode adapted to produce an electrical output signal based, at least in part, on the optically coupled signal.

3. The modulator of claim 1, further comprising:
a feedback loop operably coupling the optical output signal and the optical input signal, the feedback loop adapted to alter the optical input signal based, at least in part, on the optical output signal.

4. The modulator of claim 2, wherein the optical input signal comprises, at least in part, the optical output signal.

5. The modulator of claim 2, wherein first inverted integrator is operably coupled to a combination of the optical input signal and the optical output signal.

6. The modulator of claim 1, wherein the first inverted integrator comprises:
a first optical isolator adapted to receive the optical input signal and produce a first inverted integrator optical signal;
a first semiconductor optical amplifier operably coupled to the first optical isolator, the first semiconductor optical amplifier adapted to receive the first inverted integrator optical signal and produce a first amplified inverted integrator optical signal;
a first bandpass filter operably coupled to the first semiconductor optical amplifier, the first bandpass filter adapted to receive the first amplified inverted integrator optical signal and produce a first filtered optical signal; and
a first plurality of optical couplers operably coupled to the first bandpass filter, the first plurality of optical couplers adapted to produce the first integrated optical signal based, at least in part on, the first filtered optical signal.

7. The modulator of claim 1, wherein the first inverted integrator is based, at least in part, on the equation I₂^{λ}^{₂}[n]=a+τI₂^{λ}^{₂}[n−1]−gI₁^{λ}^{₁}[n], where n is a time value, where λ₁ is a first wavelength associated with the optical input signal, where λ₂ is a second wavelength associated with the first bandpass filter, where a=AC(1−Kᵢ)(1−K₂, where A is a real constant, where C is a real constant, where τ=−BCα(1−K₁)²(1−K₂), where B is a real constant, where g=−BCαK₁(1−K₁)(1−K₂).

8. The modulator of claim 1, wherein the second inverted integrator comprises:
a second optical isolator adapted to receive the first integrated optical signal and produce a second inverted integrator optical signal;
a second semiconductor optical amplifier operably coupled to the second optical isolator, the second semiconductor optical amplifier adapted to receive the second inverted integrator optical signal and produce a second amplified inverted integrator optical signal;
a second bandpass filter operably coupled to the second semiconductor optical amplifier, the second bandpass filter adapted to receive the second amplified inverted integrator optical signal and produce a second filtered optical signal; and
a second plurality of optical couplers operably coupled to the second bandpass filter, the second plurality of optical couplers adapted to produce the second integrated optical signal based, at least in part on, the second filtered optical signal.

9. The modulator of claim 1, wherein the second inverted integrator is based, at least in part, on the equation I₂^{λ}^{₂}[n]=a+τI₂^{λ}^{₂}[n−1]−gI₁^{λ}^{₁}[n], where n is a time value, where λ₁ is a first wavelength associated with the first integrated optical signal, where λ₂ is a second wavelength associated with the second bandpass filter, where a=AC(1−Kᵢ)(1−K₂), where A is a real constant, where C is a real constant, where τ=−BCα(1−K₁)²(1−K₂), where B is a real constant, where g=−BCαK₁(1−K₁)(1−K₂).

10. The modulator of claim 1, wherein the optical quantizer comprises:
a quantizer photodiode adapted to receive the second integrated optical signal and produce a first quantizer signal;
a comparator operably coupled to the quantizer photodiode, the comparator adapted to produce a second quantizer signal; and
a laser operably coupled to the comparator, the laser adapted to produce the optical output signal based, at least in part, on the second quantizer signal.

11. The modulator of claim 5, wherein the laser comprises one or more of a continuous wave laser, a distributed feedback laser and an electro-absorption modulator.

12. The modulator of claim 1, wherein the first inverted integrator comprises a leaky integrator.

13. The modulator of claim 1, wherein the second inverted integrator comprises a leaky integrator.

14. The modulator of claim 1, wherein the optical quantizer comprises a binary quantizer.

15. A method for a modulator to produce an asynchronous delta-sigma modulated optical output signal generated, at least in part, from an optical input signal, the method comprising:
integrating the optical input signal to produce a first integrated optical signal;
integrating the first integrated optical signal to produce a second integrated optical signal; and
optically quantizing the second integrated optical signal to produce an optical output signal.

16. The method of claim 15, the method further comprising:
optically coupling the optical output signal to produce an optically coupled signal; and
producing an electrical output signal based, at least in part, on the optically coupled signal.

17. The method of claim 15, further comprising:
altering the optical input signal based, at least in part, on the optical output signal;
repeating the integrating operations and the optically quantizing operation for the altered optical input signal.

18. A system to produce an asynchronous delta-sigma modulated output signal, at least in part, from an optical input signal, comprising:
a first inverted integrator adapted to receive the optical input signal, the first inverted integrator comprising:
a first optical isolator adapted to receive the optical input signal and produce a first inverted integrator optical signal;
a first semiconductor optical amplifier operably coupled to the first optical isolator, the first semiconductor optical amplifier adapted to receive the first inverted integrator optical signal and produce a first amplified inverted integrator optical signal;
a first bandpass filter operably coupled to the first semiconductor optical amplifier, the first bandpass filter adapted to receive the first amplified inverted integrator optical signal and produce a first filtered optical signal; and
a first plurality of optical couplers operably coupled to the first bandpass filter, the first plurality of optical couplers adapted to produce a first integrated optical signal based, at least in part on, the first filtered optical signal;
a second inverted integrator adapted to receive the first integrated optical signal, the second inverted integrator comprising:
a second optical isolator adapted to receive the first integrated optical signal and produce a second inverted integrator optical signal;
a second semiconductor optical amplifier operably coupled to the second optical isolator, the second semiconductor optical amplifier adapted to receive the second inverted integrator optical signal and produce a second amplified inverted integrator optical signal;
a second bandpass filter operably coupled to the second semiconductor optical amplifier, the second bandpass filter adapted to receive the second amplified inverted integrator optical signal and produce a second filtered optical signal; and
a second plurality of optical couplers operably coupled to the second bandpass filter, the second plurality of optical couplers adapted to produce the second integrated optical signal based, at least in part on, the second filtered optical signal;
an optical quantizer adapted to receive the second integrated optical signal, the optical quantizer comprising:
a quantizer photodiode adapted to receive the second integrated optical signal and produce a first quantizer signal;
a comparator operably coupled to the quantizer photodiode, the comparator adapted to produce a second quantizer signal; and
a laser operably coupled to the comparator, the laser adapted to produce an optical output signal based, at least in part, on the second quantizer signal;
an output optical coupler adapted to receive the optical output signal and produce an optically coupled signal based, at least in part, on the optical output signal; and
an output photodiode adapted to produce an electrical output signal based, at least in part, on the optically coupled signal.

19. The modulator of claim 18, further comprising:
a feedback loop operably coupling the optical output signal and the optical input signal, the feedback loop adapted to alter the optical input signal based, at least in part, on the optical output signal.

20. The modulator of claim 19,
wherein the first inverted integrator is adapted to receive the altered optical input signal; and
wherein the first optical isolator is adapted to receive the altered optical input signal to produce the first inverted integrator optical signal.
